(19) United States
(12) Patent Application Publication
(10) Pub. No.: US 2023/0308042 A1
(43) Pub. Date: Sep. 28, 2023

(54) SOLAR eVTOL DRONE TOWER

(71) Applicant: AMERISTAR SOLAR, LLC, BANKS, OR (US)

(72) Inventor: SIDNEY WILLIAM BOYK, BANKS, OR (US)

(21) Appl. No.: 18/159,574

(22) Filed: Jan. 25, 2023

Related U.S. Application Data
(60) Provisional application No. 63/303,803, filed on Jan. 27, 2022.

(51) Int. Cl. H02S 20/22; B64C 39/02; B60L 53/51; A62C 99/00; F42B 12/36; F42B 3/02; B64U 10/60; B64U 50/31

(52) U.S. Cl. CPC H02S 20/22; A62C 99/0009; B60L 53/51; B64C 39/024; B64U 10/60; B64U 50/31; F42B 3/02; F42B 12/36; B64U 2101/31

(57) ABSTRACT

A solar-powered fire tower structure has an array of solar panels positioned to provide power to the tower, one or more cameras to receive power from the solar panels, and a communications link to provide communication from the fire tower. A fire-retardant projectile has a casing of having a standardized size, a payload of a fire-retardant material, and a firing mechanism to propel the projectile out of a barrel.

### RELATED APPLICATIONS

This disclosure claims benefit of U.S. Provisional Application No. 63/303,803, titled “Solar eVTOL Drone Tower,” filed on Jan. 27, 2022, the disclosure of which is incorporated herein by reference in its entirety.

### TECHNICAL FIELD

This disclosure relates to solar-powered drones, more particularly to solar-powered drones that can perform vertical take-off and landing (VTOL).

### BACKGROUND

Wildfires cause millions of dollars of damage to private and public property and have caused multiple deaths. Fighting wildfires also costs millions of dollars and has cost firefighters their lives and left others injured. Having the capability to detect and fight wildfires early, and deploy means to fight them as soon as possible, would limit the amount of damage they can cause.

### BRIEF DESCRIPTION OF THE DRAWINGS

FIG. 1 shows an embodiment solar-powered drone tower having solar powered drones to locate and fight wildfires.

FIG. 2 shows an embodiment of a solar-powered drone with payload capabilities.

FIG. 3 shows an embodiment of a solar powered camera using an existing fire tower.

FIG. 4 shows an embodiment of a solar-powered camera fire tower having an unmanned ariel vehicle launch pad.

FIG. 5 shows an embodiment of a solar-powered camera fire tower with a helicopter landing and launch pad.

FIG. 6 shows an embodiment of a solar-powered dual camera fire tower with a UAV launch pad.

FIG. 7 shows an embodiment of a targeted fire suppression ring.

FIG. 8 shows an embodiment of a fire suppression round.

### DETAILED DESCRIPTION OF THE EMBODIMENTS

The embodiments here involve a solar-powered drone tower having a tethered, solar-powered drone for monitoring regions for wildfire activity. The tower also has one or more non-tethered drones, referred to here as payload drones. The tower has at least one storage. The storage may comprise tank of bomblets configured to be carried by drones or other unmanned aerial vehicles that contain fire retardant or other fire suppression material, deployable from the payload drones. When the payload drones dock, they can be refilled and re-deployed to the fires. The storage may also comprise a stockpile of munitions-based fire-retardant rounds, discussed in more detail further.

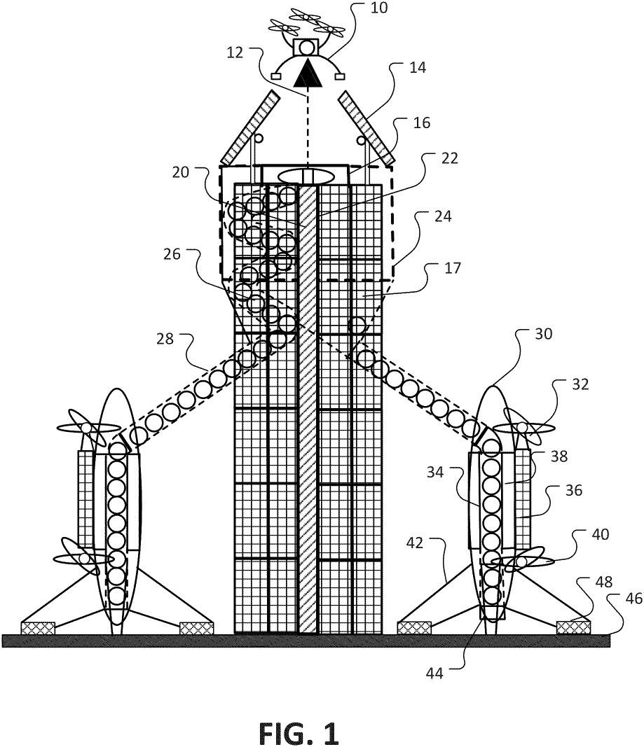

FIG. 1 shows an embodiment of a solar drone tower. The core of the tower comprises a pole 22. While the pole may comprise one of many different types of poles, such as metal, etc., telephone poles may comprise a good option as they are inexpensive and readily available. In further embodiments, the pole may be replaced with a structure, so the term “pole” as used here also means “structure.”

The pole supports an array of solar panels such as 17 that may take many different shapes or forms. In one embodiment, the array may take the form of semicircular arrays along the pole. The pole also supports a solar-powered tethered drone 10 that connects to pole 12. The discussion here may refer to this as the lookout drone and may comprise a drone as set out in U.S. Pat. No. 10,239,613, “Solar Powered Tethered Drone.”

The poles may reside at the tops of mountains or hills in the region desiring fire lookout and elimination, like the watchtowers previously used by forest services. The lookout drone deploys on a regular schedule, or as needed, through a hinged roof of tower 14. The tether 12 extends and retracts using a mechanism such as a reel box 16. The lookout drone may extend at least 400 feet above the pole and uses solar panels on the tower to power itself and any onboard equipment. The lookout drone may include infrared (IR) and visual, long-distance cameras, and a global positioning system (GPS). An on-board computer, or a computer in the tower, analyzes the data and determines a location and flight vector to any detected fire.

The lookout drone monitors the area for smoke or heat signature that indicates a fire. An interior silo tank/reservoir 24 holds several bomblets full of fire-retardant materials. The silo tank 24 is loaded by a conveyor tube 20. The fire drones such as 30 transport the bomblets 26 to the fire and deposit the bomblets to control the fire. The drones receive the bomblets through a feed tube 28 into an internal bomblet tube 34, when the drones are docked on the charging deck 46.

The lookout drone may also serve as a beacon antenna to send messages to other towers in the region. The towers in a region may communicate about the status of the sorties, such as their number, and their success. They can contact the local forestry services, communicate with the fire drones to ensure their return to base, act as a security lookout for the tower itself, etc. The tethered drone may also have smaller drones that launch and return to the “mother” tethered drone, or to the landing dock.

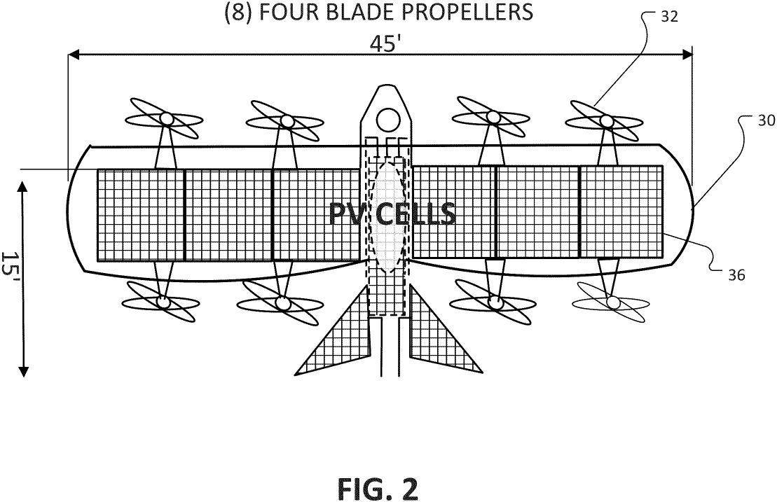

The drones have two or more propellers such as 32 and 40 that swivel to allow the fire drones to take off and land vertically but fly horizontally. The fire drones hover over the fire and turn again vertically to dispense bomblets out of the tube onto the fire. A door 44 opens to allow the bomblets to disperse. Fins such as 42 support the drone in the landing position and may comprise three rigid fins and one that retracts when the drone is docked. The ends of the feet, such as 48 may have cathode and anode contacts that allow the battery 38 to charge from the dock. The battery 38 may also charge through the solar panels such as 36. Software in the main tower control system may control the drone flight, hover and docking process to ensure that the drone docks correctly to the charging deck. A more detailed view of the fire drone is shown in FIG. 2.

The control system may also manage the flight of the drone and dispersion of the bomblets. If the drone(s) drop the payloads off target, the system adjusts their flight path and drop zone to correct the drop on the next path. This system allows for early detection of wildfires and then on-site firefighting within a very short period of time before personnel and equipment can reach the fires. They also provide the ability to fight fires in remote areas that are otherwise unreachable for extended periods of time with multiple drops, possibly even to get the fire under control, contained or even to put it out. In one embodiment, the fire towers would be constructed in a 386 square mile area, such as in four quadrants of the overall square mile area.

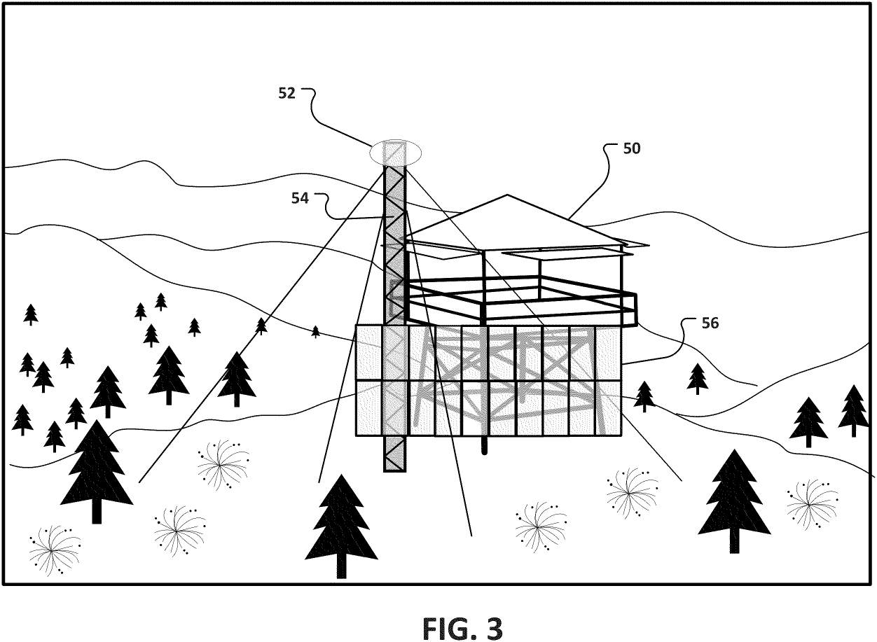

In another embodiment, the solar-powered fire tower is mounted to an existing fire tower, or a remote peak as shown in FIG. 3. While the discussion may refer to these and other embodiments as fire towers, no intention is intended to limit the installations to existing fire towers. The installation could occur at any remote peak. In the embodiment of FIG. 3, for example, the fire tower is mounted to an existing fire tower 50, but that is not necessary. An artificial intelligence/machine learning camera system 52 is mounted to a guy-wired tower 54. In some embodiments, the guy-wired tower may be a 200′ tower and may comprise carbon fiber, or any other lightweight strong material. The tower may reach the location by helicopter, so being lightweight may become important. Solar panels such as 56 would reside on the base of the fire tower 50, or on the peak adjacent to the tower 54 to provide power to the camera 52. The system would also include a communications link, such as that shown in FIG. 1, to allow the camera system to send an alert if the camera detects a fire. The camera may also just be monitored in real time to allow a remote operator to monitor the feed. The ML system would identify likely hot spots or fires and adjust to monitor those locations.

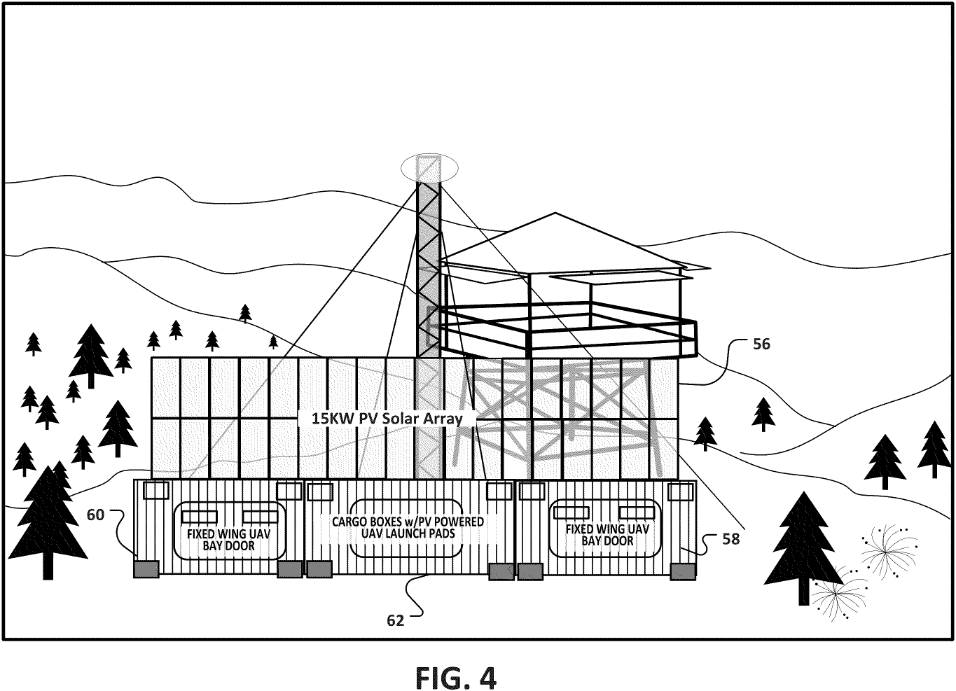

The camera capability may be combined with the UAV launch pad as shown in FIG. 4. In FIG. 4, the fire tower includes a launch pad for one or more UAVs. The solar panels such as 56 again provide power. However, in this embodiment, they mount to one or more containers 58, 60 and 62. The containers, or other structures, provide hangers for fixed wing UAVs in the examples of containers 58 and 60. Box 62 may contain the control system or other elements to the system that provides charging to the UAVs. If the UAVs have fire suppression capabilities, they may also contain fire suppression materials.

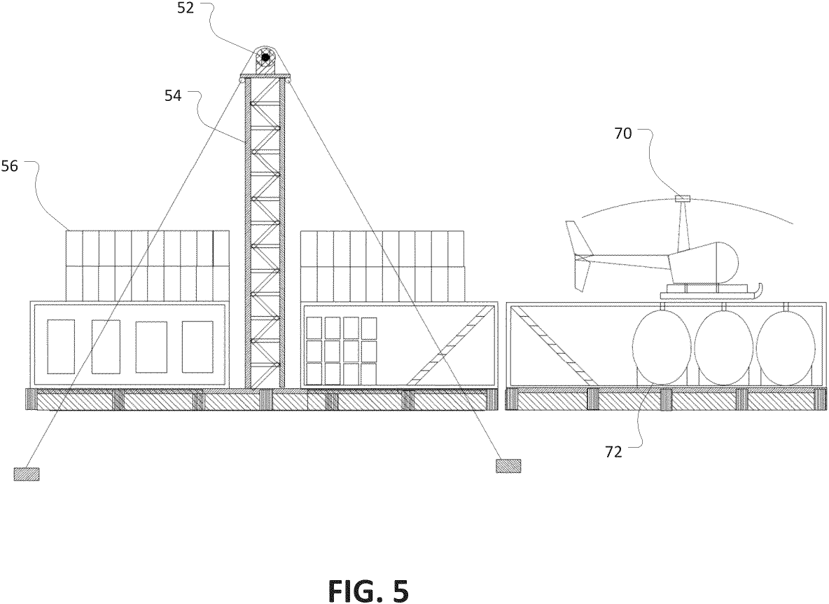

The tower 54 with is camera 52 may deploy as part of many other configurations. FIG. 5 shows a configuration in which the tower and camera are powered by solar panels such as 56. They may or may not reside adjacent to the containers as shown in FIG. 4. Further, a helicopter such as 70, which may comprise a type 1, type 2, or type 3 helicopter capable of carrying firefighters and a payload of fire suppression materials such as that shown at 72.

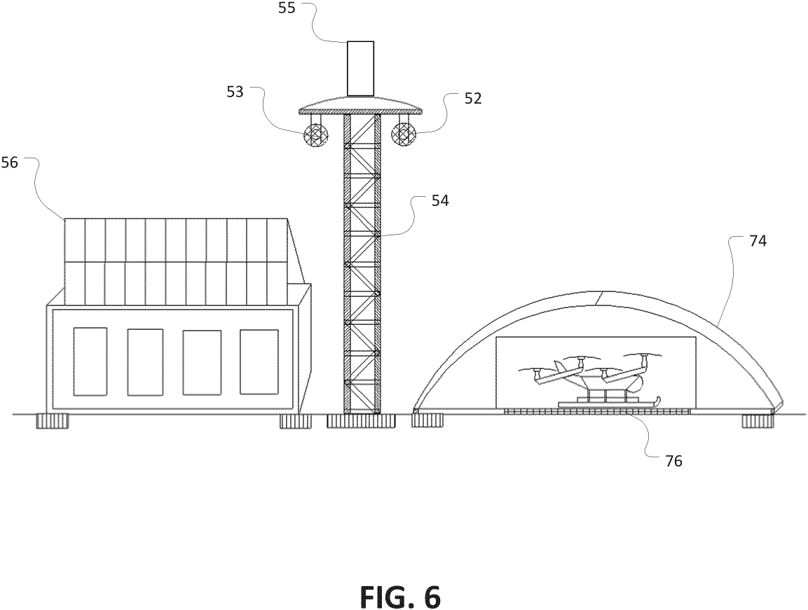

Any of the above variations and combinations may be mixed and matched as needed for a particular environment and/or use. FIG. 6 shows another embodiment. The tower 54 now holds two or more cameras 52 and 53. Using two cameras in slightly different locations allows for triangulation of a location and a better estimate of distance with a fire is spotted. The container below has the solar panels such as 56 to provide power to the cameras and the installation as needed. Hangar 74 provides storage and cover for the vehicle 76, which may be a helicopter or a UAV, as desired.

In addition, the tower has a 4G/5G, or their successors, communications link 55. This allows the tower to communicate with external parties, such as the US Forest Service, etc., through a cellular network in accordance with whatever standard is currently being used. This link may be in addition to, or instead of, traditional radio communications typically used by the USFS. It allows interested parties, including nearby landowners, etc., to track spotted fires, and the progress of the fire and fire suppression activities. In addition or instead of being attached to the physical structure of the tower, the link may be mounted to a tethered drone. During emergency situations, such a fires, floods or other disruptions of service, the tethered drone or the tower could provide temporary services to parties within the eVTOL locations.

The towers may operate in an automated fashion with remote monitoring and communications through the cameras, or may be manned towers, with firefighters, forest rangers, etc., providing a human presence. The human(s) may monitor the cameras, operate the UAVs or pilot helicopters, prepare the drones, etc. In those instances, the containers may also include living quarters and facilities for humans. The humans will have access to the launchpad and can provide repair services as needed. As the UAVs, or drones, deploy into hazardous situations, there is a high possibility that they will need repair. The facilities may also include inventory of spare parts and tools.

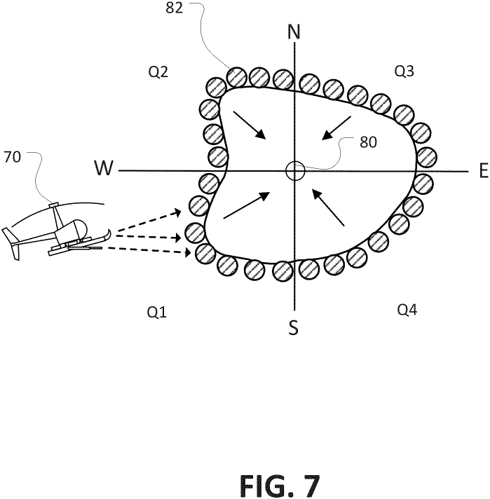

FIG. 7 shows an embodiment of a fire suppression technique usable with the vehicle 76 of FIG. 6, which may be a helicopter such as 70 shown in FIG. 5. The technique surrounds the center of the fire 80 with a ring of explosions such as 82 delivered from the helicopter or other aerial vehicle. The explosions result from the use of a pyrotechnic shell that delivers a percussive explosion and a biodegradable, non-toxic fire retardant at the same time. The explosions blast the oxygen from the fuel source, pushing the fuel source back towards the center of the fire to eliminate it at the edge of the fire. The pyrotechnic shell provides one example of a munitions-based fire-retardant round. “Munitions-based” as used here means a projectile that mimics or comprises some sort of munition, such as a grenade launched from a grenade launcher, or other standardized munition such as artillery shells, machine-gun rounds, etc.

These explosions may result from the use of a 40-mm round, such as those used in the US Army standard M79 grenade launcher, although that is just one example. Other sizes may also be employed. The 40-mm round has some advantages. These include the ability of a helicopter to hold four hundred 40-mm rounds only weighing about 200 pounds. The center cores of these rounds can hold many types of retardants in different volumes and different configurations and detonations patterns and timing. This may replace several thousands of gallons of water and air dropped retardants that have a low percentage hit rate and may evaporate before landing on the fire. The vehicles here can fly at night, a period which is best for fighting fires and often when other vehicles cannot fly due to low visibility.

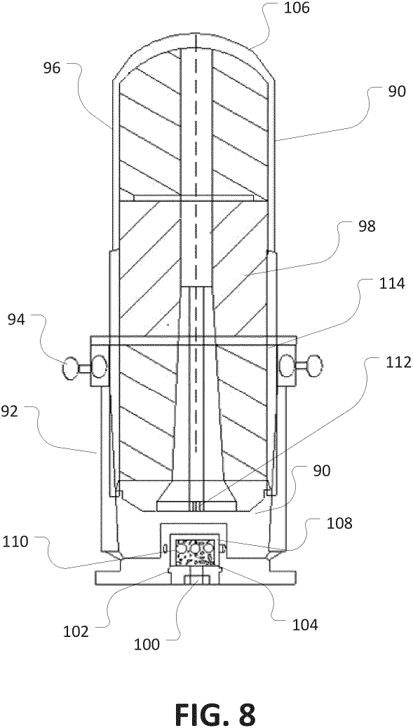

FIG. 8 shows an embodiment of such a round 90. While envisioned as a 40-mm round, one should note that this round may be of many different configurations and sizes, and the components of the round may have different shapes, sizes, and locations. The round 90 resides in a brass or other metal cartridge 92 that can be belt fed by using connectors such as 94 that allow rounds to be connected into a belt of rounds. The connectors allow the rounds to be linked together into a belt, such that as one round is fired, the next round in the belt feeds into the chamber. Belt-fed weapons include many common soldier-carried machine guns and vehicle-mounted machine guns, whether the vehicle is an automobile, truck, armored vehicle, manned aircraft, and unmanned aerial vehicles. The connectors here are unique and comprise part of the casing, with an anchor portion as part of the casing and a mating portion that extends outside the casing. This allows the next adjacent round to attach to the current round in a unique fashion, eliminating an external connector, link the ‘disintegrating link’ commonly used on belt fed weapons, where the connectors disengage when the round contained by them fires.

One should note that other types of rounds may be used that are not belt fed, such as artillery or mortar shells. The casing or cartridge of the round may comprise a standardized, typically military or law enforcement sized round, such as a 105-mm howitzer round, a 40-mm grenade round, an 82-mm mortar shell, etc. This discussion refers to these as ‘standardized’ sizes.

Casing 92 contains fuselage 96 that carries the payload of the round 98, which in this case is a fire-retardant material. In one embodiment, the fire retardant may comprise a pyrotechnic gel including a non-toxic, alginate-geopolymer, basalt fiber fire retardance mixture. The base plug 100 of the cartridge has a percussion primer 102 that ignites when struck with a firing pin. The primer causes the larger charge, typically the propellant, to ignite that propels the round out of the barrel of whatever “weapon” is firing the round. The term “barrel” as used here means any structure through which a round moves once the primer has been fired. In the fire suppression world, the device is not a weapon, but it may take the form of the weapon. High pressure 104 chamber under the propellant cup 108, has vent holes 110 that allow excess gases to escape the chamber, as the other gases propel the round outwards. The timer fuse 112 then causes the round to detonate when it reaches the target. In one embodiment the timer fuse comprises a geopolymer basalt fiber precision timer fuse insert. As the round fires and strikes the target, reducing any remaining materials becomes important. In one embodiment, nose cone 106 may comprise a biodegradable material, reducing any remnant materials.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A solar-powered fire tower structure, comprising:
an array of solar panels positioned to provide power to the tower;
one or more cameras to receive power from the solar panels; and
a communications link to provide communication from the fire tower.

2. The fire tower structure as claimed in claim 1, wherein the structure comprises one of a pole, an existing structure, an existing fire tower, or a structure built to support the fire tower.

3. The fire tower structure as claimed in claim 1, wherein at least one of the cameras is mounted to a solar-powered drone tethered to the tower.

4. The fire tower structure as claimed in claim 3, further comprising solar-powered drones having fire retardant payloads arranged to receive power from the solar panels.

5. The fire tower structure as claimed in claim 1, wherein the at least one camera is mounted to the structure.

6. The fire tower structure as claimed in claim 1, wherein the one or more cameras comprises at least one of an infrared camera, an artificial intelligence/machine learning camera, and a long-distance camera.

7. The fire tower structure as claimed in claim 1, wherein the fire tower further comprises a stock of fire-retardant containers.

8. The fire tower structure as claimed in claim 7, wherein the fire-retardant containers comprise one of bomblets with a fire-retardant payload or munitions rounds with fire retardant payloads.

9. The fire tower structure as claimed in claim 1, wherein the fire tower further comprises a storage and fire-retardant containers in the storage.

10. The fire tower as claimed in claim 1, wherein the fire tower further comprises a platform for an aerial vehicle.

11. The fire tower as claimed in claim 9, wherein the aerial vehicle comprises one of a manned or unmanned aerial vehicle.

12. The fire tower as claimed in claim 1, wherein the communications link comprises a cellular network connection.

13. The fire tower as claimed in claim 1, wherein the communications link is mounted on a tethered drone that can deploy during interruptions of communication services.

14. The fire tower as claimed in claim 1, further comprising living quarters and facilities for people manning the tower.

15. A fire-retardant projectile, comprising:
a casing of having a standardized size;
a payload of a fire-retardant material; and
a firing mechanism to propel the projectile out of a barrel.

16. The fire-retardant projectile as claimed in claim 15, wherein the standardized size corresponds to a standard belt-fed round and the casing further comprises connectors to allow the projectile to be connected to other projectiles in a belt.

17. The fire-retardant projectile as claimed in claim 15, wherein the standardized size further comprises 40-mm.

18. The fire-retardant projectile as claimed in claim 15, further comprising a biodegradable nose cone.

19. The fire-retardant projectile as claimed in claim 15, wherein the fire-retardant material comprises pyrotechnic gel including a non-toxic, alginate-geopolymer basalt fiber material.

20. The fire-retardant projectile as claimed in claim 15, further comprising a connector to allow the projectile to be connected to other projectiles in a belt, the connector comprising a first portion integrated into the casing, and a second portion that extends out from the casing to allow the projectile to connect to second portions of connectors on other projectiles.
